(19) United States
(12) Patent Application Publication
(10) Pub. No.: US 2016/0308625 A1
(43) Pub. Date: Oct. 20, 2016

(54) WIRELESS TRANSMISSION DEVICE, AND METHOD FOR CONNECTING A WIRELESS TRANSMISSION DEVICE WITH A MOBILE COMMUNICATION DEVICE

(71) Applicant: ROUND TEK LTD., New Taipei City (TW)

(72) Inventor: HSIAO-CHI CHEN, NEW TAIPEI CITY (TW)

(21) Appl. No.: 15/194,769

(22) Filed: Jun. 28, 2016

Related U.S. Application Data
(63) Continuation-in-part of application No. 14/305,091, filed on Jun. 16, 2014, now Pat. No. 9,414,308.

(30) Foreign Application Priority Data
Jul. 22, 2013 (TW) 102213772
Feb. 10, 2014 (TW) 103104234
Feb. 19, 2016 (TW) 105104916

(51) Int. Cl. H04B 17/12; H01Q 3/02; H04W 76/02; H04B 17/318

(52) U.S. Cl. CPC H04B 17/12; H04B 17/318; H01Q 3/02; H04W 76/02; H04W 84/12

(57) ABSTRACT

The instant disclosure illustrates a wireless transmission device and a method for connecting a wireless transmission with a mobile communication device, the wireless transmission device includes a base unit, a control unit, a steering unit and an antenna unit. The control unit is arranged on the base unit. The steering unit is arranged on the base unit and is electrically connected to the control unit. The antenna unit is arranged on the steering unit and is electrically connected to the control unit. The control unit controls the direction of rotation of the steering unit according to a signal measurement value between the antenna unit and the mobile communication device for steering the antenna unit arranged on the steering unit.

### CROSS REFERENCE TO RELATED APPLICATION

This application is a continuation-in-part of U.S. application Ser. No. 14/305,091, filed on 16 Jun. 2014 and entitled “METHOD OF CONTROLLING WIRELESS NETWORK DEVICE FOR NETWORK CONNECTIVITY”, now pending, the entire disclosures of which are incorporated herein by reference.

### BACKGROUND

1. Technical Field

The instant disclosure relates to a wireless transmission device and method for connecting a wireless transmission device with a mobile communication device, in particular, to a wireless transmission device and method for connecting a wireless transmission device with a mobile communication device for improving the communication quality of the mobile communication device.

2. Description of Related Art

The existing wireless communication devices such as access points (AP) may provide the service of wireless networking through wireless communication techniques. Generally, the wireless communication devices establish the wireless connection (Wi-Fi) with the mobile communication devices based on the wireless signal emitted by an omni-directional antenna.

However, the intensity of the wireless network signal transceived by the mobile communication devices is affected by environmental conditions (such as the presences of decoration, equipment, and shelters such as walls). When the user uses a mobile communication device, the intensity of the received signal varies according to the different position of the mobile communication device. In order to enhance the wireless network signal received by the mobile communication device, the user has to move the mobile communication device toward the wireless transmission device or far from the walls, or manually adjust the angle of the mobile communication device.

Therefore, there is a need of providing a wireless transmission device and a method for controlling the connection of the wireless transmission device to overcome the above disadvantages.

### SUMMARY

The problem to be solved in the instant disclosure is to provide a wireless transmission device and a method for controlling the connection of the wireless transmission device for improving the communication quality of the mobile communication device.

In order to solve the above technical issues, an embodiment of the present disclosure provides a wireless transmission device for connecting a mobile communication device, comprising a base unit, a control unit, a steering unit and an antenna unit. The control unit is arranged on the base unit. The steering unit is arranged on the base unit and is electrically connected to the control unit. The antenna unit is arranged on the steering unit and is electrically connected to the control unit. The control unit controls the direction of rotation of the steering unit according to a signal measurement value between the antenna unit and the mobile communication device for steering the antenna unit arranged on the steering unit.

Another embodiment of the instant disclosure provides a method for connecting a wireless transmission device and a mobile communication device, comprising: establishing a wireless connection between the wireless transmission device and the mobile communication device; detecting a signal measurement value between an antenna unit positioned at a predetermined position and the mobile communication device; driving the antenna unit to rotate toward a first direction to another predetermined position for detecting another signal measurement value between the antenna unit and the mobile communication device; and judging whether a signal measurement value detected laterally is larger than a signal measurement value detected previously; in which when the signal measurement value detected laterally is not larger than the signal measurement value detected previously, driving the antenna unit to rotate toward a second direction to yet another predetermined position for detecting yet another signal measurement value between the antenna unit and the mobile communication device; and in which when the signal measurement value detected laterally is larger than the signal measurement value detected previously, driving the antenna unit to rotate toward the first direction for detecting another signal measurement value.

Yet another embodiment of the instant disclosure provides a method for connecting a wireless transmission device and a mobile communication device, comprising: establishing a wireless connection between the wireless transmission device and the mobile communication device; driving an antenna unit to rotate toward a first direction; judging whether a current signal measurement value detected after the antenna unit rotates toward the first direction is larger than a previous signal measurement value detected before the antenna unit rotates toward the first direction, in which when the current signal measurement value detected after the antenna unit rotates toward the first direction is not larger than the previous signal measurement value detected before the antenna unit rotates toward the first direction, driving the antenna unit to rotate toward a second direction; and judging whether a current signal measurement value detected after the antenna unit rotates toward the second direction is larger than a previous signal measurement value detected before the antenna unit rotates toward the second direction, in which when the current signal measurement value detected after the antenna unit rotates toward the second direction is not larger than the previous signal measurement value detected before the antenna unit rotates toward the second direction, driving the antenna unit to rotate toward the first direction.

The advantages of the instant disclosure are that the wireless transmission device and the method for connecting a wireless transmission device and a mobile communication device may continuously detect the signal measurement value between the wireless transmission device and the mobile communication device for adjusting the direction of rotation of the antenna unit, thereby maintaining a best signal measurement value and communication quality between the wireless transmission device and the mobile communication device.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a function block diagram of the wireless transmission device provided by a first embodiment of the instant disclosure.

FIG. 2 is an operation schematic view of the wireless transmission device and the mobile communication device of the first embodiment of the instant disclosure.

FIG. 3 is a schematic view of the use of the wireless transmission device and the mobile communication device of the embodiments of the instant disclosure.

FIG. 4 is another schematic view of the use of the wireless transmission device and the mobile communication device of the embodiments of the instant disclosure.

FIG. 5 is a flow chart of the method for connecting a wireless transmission device and a mobile communication device provided by a second embodiment of the instant disclosure.

FIG. 6 is another flow chart of the method for connecting a wireless transmission device and a mobile communication device provided by the second embodiment of the instant disclosure.

FIG. 7 is a flow chart of the method for connecting a wireless transmission device and a mobile communication device provided by a third embodiment of the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

### First Embodiment

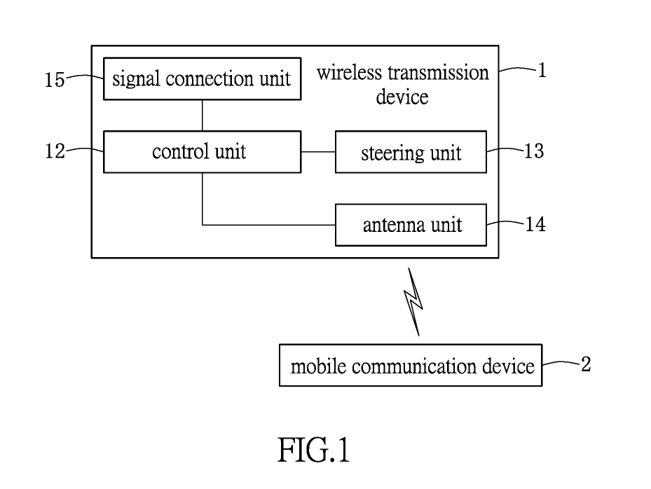

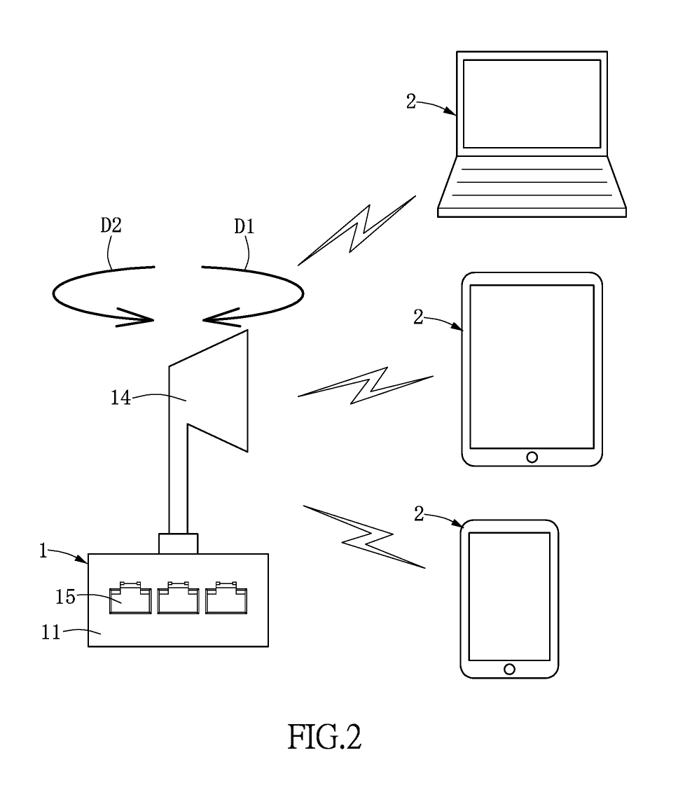

Please refer to FIG. 1 and FIG. 2. The embodiments of the instant disclosure provide a wireless transmission device 1 for connecting with a mobile communication device 2. The wireless transmission device 1 comprises a base unit 11, a control unit 12, a steering unit 13, and an antenna unit 14. Preferably, the wireless transmission device 1 further comprises a signal connection unit 15. For instance, the signal connection unit 15 may be a network connecting socket (RJ45 terminal) electrically connected to a network signal port (not shown) through the signal connection unit 15 for receiving or transmitting digital information and transmitting the digital information received by the network signal port to the mobile communication device 2. Therefore, the mobile communication device 2 may conduct network connection. In other words, the wireless transmission device 1 provided by the instant disclosure corresponds to a router, an access point (AP), a wireless access point (WAP), a Bluetooth connecting device, a Wi-Fi device or other devices with wireless transmission function. However, the instant disclosure is not limited thereto.

In the embodiments of the instant disclosure, the antenna unit 14 may be a single antenna or two or more antennas. When the antenna unit 14 is a single antenna, the antenna unit 14 may perform time-division and multiplexing works for receiving and transmitting signals. When the antenna unit 14 is a plurality of antennas, the receiving and transmitting may be carried out separately.

The base unit 11 may be a housing or a base for bearing the other components. The control unit 12 may be arranged on an electric circuit substrate (not shown) and arranged on the base unit 11 through the electric circuit substrate. In addition, the control unit 12 may be a microcontroller unit (MCU). However, the instant disclosure is not limited thereto. Furthermore, the steering unit 13 may be arranged on the base unit 11, and the antenna unit 14 may be arranged on the steering unit 13. Alternatively, the antenna unit 14 may be arranged on the steering unit 13 through a rotation plate (not shown). The steering unit 13 and the antenna unit 14 may be electrically connected to the control unit 12 respectively. For instance, in the embodiments of the instant disclosure, the steering unit 13 may be a motor (such as a stepping motor) controlled by the control unit 12 for rotating.

The control unit 12 may control the direction of rotation (or the angle of rotation) of the steering unit 13 according to a signal measurement value between the antenna unit 14 and the mobile communication device 2 for steering the antenna unit 14 on the steering unit 13. For instance, the steering unit 13 may drive the antenna unit 14 to rotate toward a first direction D1 (clockwise) or a second direction D2 (counterclockwise), i.e., the first direction D1 and the second direction D2 are different from each other or opposite to each other. Therefore, the control unit 12 may continuously determine the position of the best (maximum) signal measurement value according to the received signal measurement value. In addition, although the antenna unit 14 shown in the figures is rotated along the horizontal direction, the antenna unit 14 may be driven by another steering unit 13 and rotate along a vertical direction relative to the horizontal direction (trimming rotation). Therefore, the signal connection between the wireless transmission device 1 and mobile communication devices 2 at different heights (such as at different floors) may be enhanced.

The antenna unit 14 may be a directional antenna. Preferably, in the embodiments of the instant disclosure may further comprise an isotropic antenna. Therefore, the mobile communication device 2 not covered by the wireless network space range of the directional antenna may establish connection through the isotropic antenna (not shown).

In other words, if the mobile communication device 2 is an electronic communication device such as mobile phone, a notebook or a media tablet and enters the wireless network space covered by the wireless transmission device 1, the antenna unit 14 and the mobile communication device 2 will establish a wireless contact such as wireless contact by wireless fidelity (Wi-Fi) technique. When the user considers the signal intensity of the mobile communication device 2 to be insufficient or need improvement, the user may adjust the wireless transmission device 1 through the mobile communication device 2 to enhance the signal measurement value between the mobile communication device 2 and the antenna unit 14.

For instance, when the mobile communication device 2 is near to the radiation field emitted by the antenna unit 14 or is relatively far from the antenna unit 14, the mobile communication device 2 is not able to effectively receive/transmit the wireless signal generated by the wireless transmission device 1. In other words, the mobile communication device 2 only receives a weak wireless signal generated by the antenna unit 14 (which is a directional antenna or an omni-directional antenna). Meanwhile, the received signal strength indication (RSSI) or signal-to-noise ratio (SNR) of the wireless signal of the mobile communication device 2 is reduced. Therefore, the mobile communication device 2 may output a controlling signal to the wireless transmission device 1 for enabling the wireless transmission device 1 to adjust the antenna unit 14 in view of the weak wireless network signal received by the mobile communication device 2. The user may control the mobile communication device 2 to output the controlling signal to the wireless transmission device 1 through an application in the mobile communication device 2, however, the manner for outputting the controlling signal is not limited in the instant disclosure.

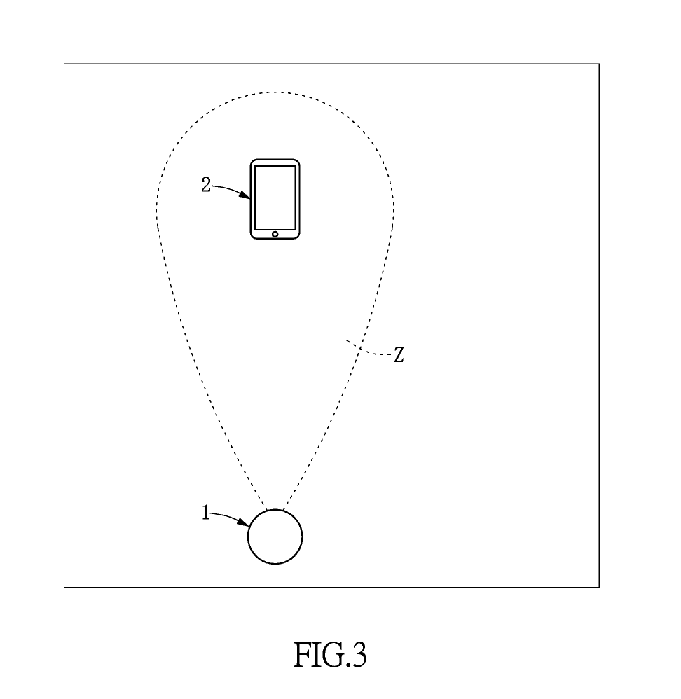

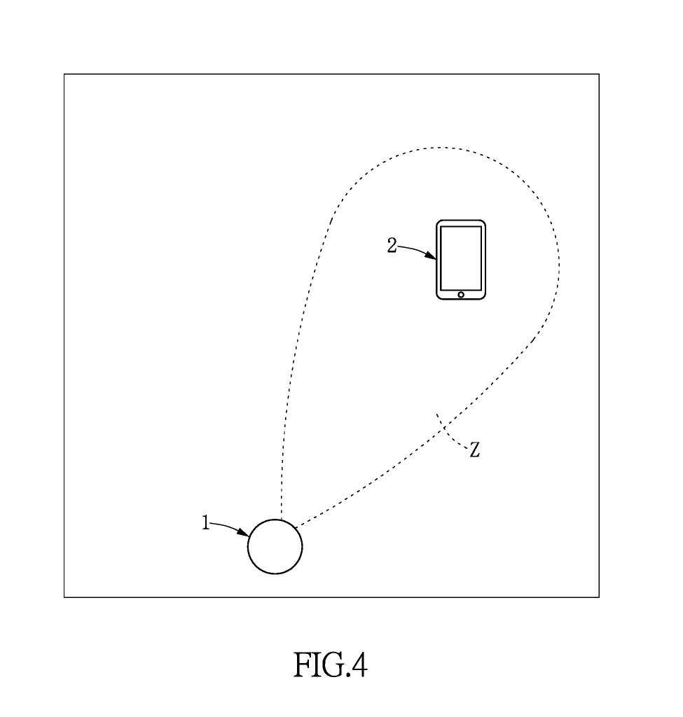

Next, please refer to FIG. 3 and FIG. 4. The control unit 12 may receive the controlling signal from the mobile communication device 2 through the antenna unit 14, thereby generating a driving signal for controlling the steering unit 13. Therefore, the antenna unit 14 starts to rotate for enhancing the intensity between the mobile communication device 2 and the wireless transmission device 1. To be specific, when the mobile communication device 2 outputs the controlling signal, the direction of the antenna radiation field Z emitted by the antenna unit 14 may point to the mobile communication device 2, and when the user moves with the mobile communication device 2, the antenna unit 14 may be driven by the steering unit 13 and rotates, thereby enabling the antenna radiation field Z emitted by the antenna unit 14 to continue to point at the mobile communication device 2, or position the antenna unit 14 at a position corresponding to the mobile communication device 2 having a best signal measurement value. In other words, other mobile communication devices 2 in the range of the antenna radiation field Z may have enhanced signal intensity based on the mobile communication device 2 generating the controlling signal. In other embodiments, a plurality of antenna units 14 may be arranged for corresponding to a plurality of mobile communication devices 2, however, the instant disclosure is not limited thereto.

### Second Embodiment

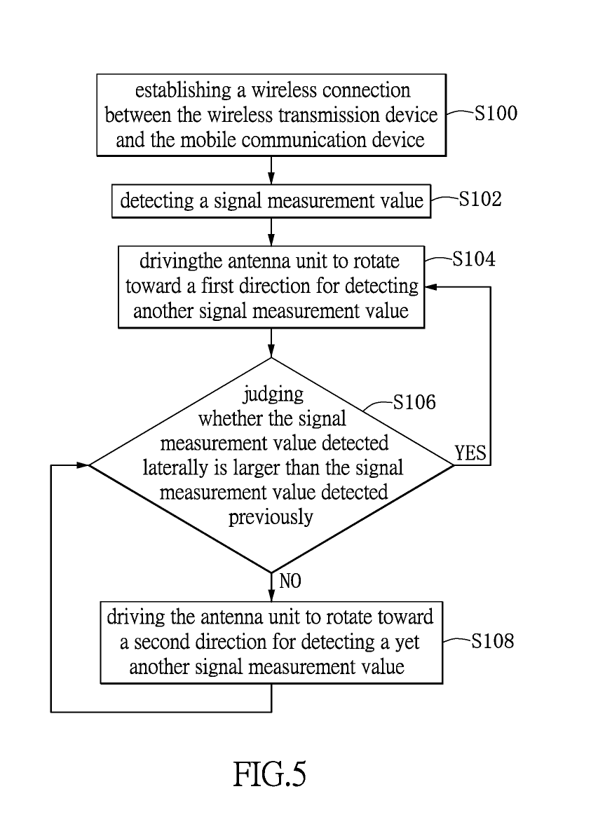

First, please refer to FIG. 5, and refer to FIG. 1 and FIG. 2 as needed. The second embodiment of the instant disclosure provides a method for connecting a wireless transmission device and a mobile communication device, comprising the steps of: as shown in step S100 (corresponding to step (a)), establishing a wireless connection between the wireless transmission device 1 and the mobile communication device 2. For instance, the establishment of the wireless connection may be achieved by an application in the mobile communication device 2 through an automatic way or be conducted manually to connect to the wireless transmission device 1.

As shown in step S102 (corresponding to step (b)), detecting a signal measurement value between an antenna unit 14 positioned at a predetermined position and mobile communication device 2. For instance, the newest signal measurement value may be obtained by continuously measuring the signal measurement value, and the received signal strength indication or signal-to-noise ratio between the antenna unit 14 and the mobile communication device 2 may be detected by the control unit 12.

As shown in step S104 (corresponding to step (c)), driving the antenna unit 14 to rotate toward a first direction D1 to another predetermined position for detecting another signal measurement value. To be specific, the antenna unit 14 may be driven by the steering unit 13. The first direction D1 may be clockwise or counterclockwise along the horizontal direction of the antenna unit 14, and when the antenna unit 14 rotates toward the first direction D1 for a predetermined distance or a predetermined angle, the control unit 12 measures another signal measurement value between the antenna unit 14 and the mobile communication device 2. Therefore, by performing step S102 and step S104, two sets of the signal measurement value at different positions may be generated.

As shown in step S106 (corresponding to step (d)), judging whether the signal measurement value between the antenna unit 14 and the mobile communication device 2 detected laterally is larger than the signal measurement value detected previously. To be specific, the signal measurement value between the antenna unit 14 and the mobile communication device 2 detected laterally corresponds to the signal measurement value which is detected after the antenna unit 14 rotates toward the first direction D1 to another predetermined position, i.e., the newest signal measurement value. In addition, the signal measurement value between the antenna unit 14 and the mobile communication device 2 detected previously corresponds to the signal measurement value detected before the antenna unit 14 rotates toward the first direction D1 to a predetermined position, i.e., the previously detected signal measurement value relative to the newest signal measurement value.

Next, judging whether the signal measurement value detected laterally is larger than the signal measurement value detected previously, and when the signal measurement value detected laterally is larger than the signal measurement value detected previously, go back to step S104, continuously driving the antenna unit 14 to rotate toward the first direction D1 for obtaining a new signal measurement value.

In other words, since the signal measurement value detected laterally is larger than the signal measurement value detected previously, the signal between the antenna unit 14 and the mobile communication device 2 is getting better while the antenna unit 14 continuously rotates toward the first direction D1. Therefore, the antenna unit 14 keeps rotating toward the same direction.

As shown in step S108, when the signal measurement value detected laterally is not larger than the signal measurement value detected previously, driving the antenna unit 14 to rotate toward a first direction D1 to yet another predetermined position for detecting a yet another signal measurement value. To be specific, since the signal measurement value detected laterally is not larger than the signal measurement value detected previously, the signal between the antenna unit 14 and the mobile communication device 2 is getting worse as the antenna unit 14 continuously rotates toward the first direction D1. Therefore, the direction of the rotation must be changed.

Next, after performing step S108, go back to step S106 for continuously judging whether the signal measurement value between the antenna unit 14 and the mobile communication device 2 detected laterally is larger than the signal measurement value between the antenna unit 14 and the mobile communication device 2 detected previously by the control unit 12. In other words, judging whether the signal measurement value detected after the antenna unit 14 rotates toward the second direction D2 is larger than the signal measurement value detected before the antenna unit 14 rotates toward the second direction D2.

Preferably, in order to find out the position of a best signal measurement value between the antenna unit 14 and the mobile communication device 2 more quickly, further driving the antenna unit 14 to rotate toward the first direction D1 (or the second direction D2) for a complete turn for recording the position of the best signal measurement value between the antenna unit 14 and the mobile communication device 2 before performing step S102. Next, driving the antenna unit 14 to the position of the best signal measurement value by the steering unit 13. In other words, by rotating the antenna unit 14 to the position having the best signal measurement value in advance, the best signal measurement value may be obtained more quickly while performing step S102 and step S108, as shown in step S102 and step S108, by continuously rotating the antenna unit 14 to the position having the best signal measurement value for maintaining the best signal measurement value.

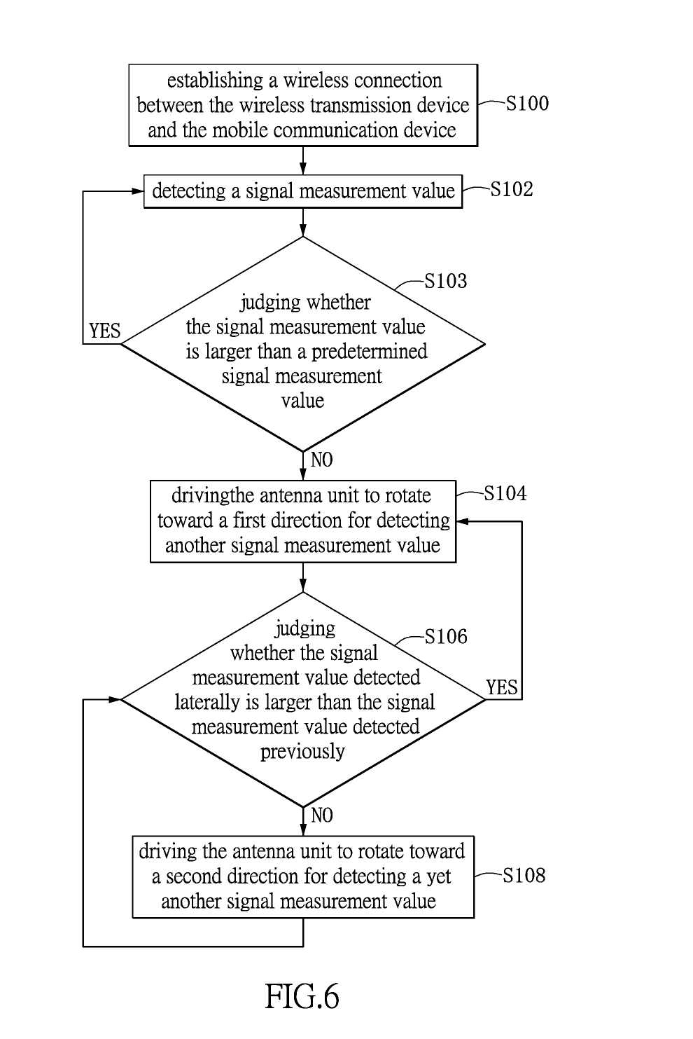

Next, please refer to FIG. 6. Comparing FIG. 5 and FIG. 6, the embodiment of FIG. 6 further comprises a step for judging whether the signal measurement value is larger than a predetermined signal measurement value. To be specific, as shown in step S103, judging whether the signal measurement value between the antenna unit 14 positioned at the predetermined position and the mobile communication device 2 is larger than a predetermined signal measurement value. The predetermined signal measurement value is a threshold for judging whether there is a need to change the direction of rotation of the antenna unit 14. When the signal measurement value between the antenna unit 14 positioned at the predetermined position and the mobile communication device 2 is not larger than the predetermined signal measurement value, performing step S104. Under this circumstance, the signal intensity is too low and there is a need for driving the antenna unit 14 to change the direction of rotation. In addition, when the signal measurement value between the antenna unit 14 positioned at the predetermined position and the mobile communication device 2 is larger than the predetermined signal measurement value, go back to step S102 for continuously detecting a signal measurement value. Since the signal measurement value would continue to change, a predetermined time may be further set when performing step S102 for saving energy. The predetermined time is for determining the interval between the judgments of the signal measurement value between the antenna unit 14 positioned at the predetermined position and the mobile communication device 2.

In other embodiments, the step of judging whether the signal measurement value between the antenna unit 14 at the predetermined position and the mobile communication device 2 is larger than a predetermined signal measurement value may be performed after detecting another signal measurement value or after detecting yet another signal measurement in order to prevent the antenna unit 14 from continuing to rotate when the signal intensity remains at a certain level.

If the another signal measurement value or the yet another signal measurement value detected when the antenna unit 14 is positioned at another predetermined position or yet another predetermined position respectively is larger than the predetermined signal measurement value, stop the rotation of antenna unit 14 until the signal measurement value is not larger than the predetermined signal measurement value. When the signal measurement value is not larger than the predetermined signal measurement value, continue to rotate the antenna unit 14.

After performing the step of judging whether the signal measurement value detected laterally is larger than the signal measurement value detected previously, the method provided by the instant disclosure may further comprise: calculating the relative position between the mobile communication device 2 and the wireless transmission device 1. The detail of the above step is described in the third embodiment.

### Third Embodiment

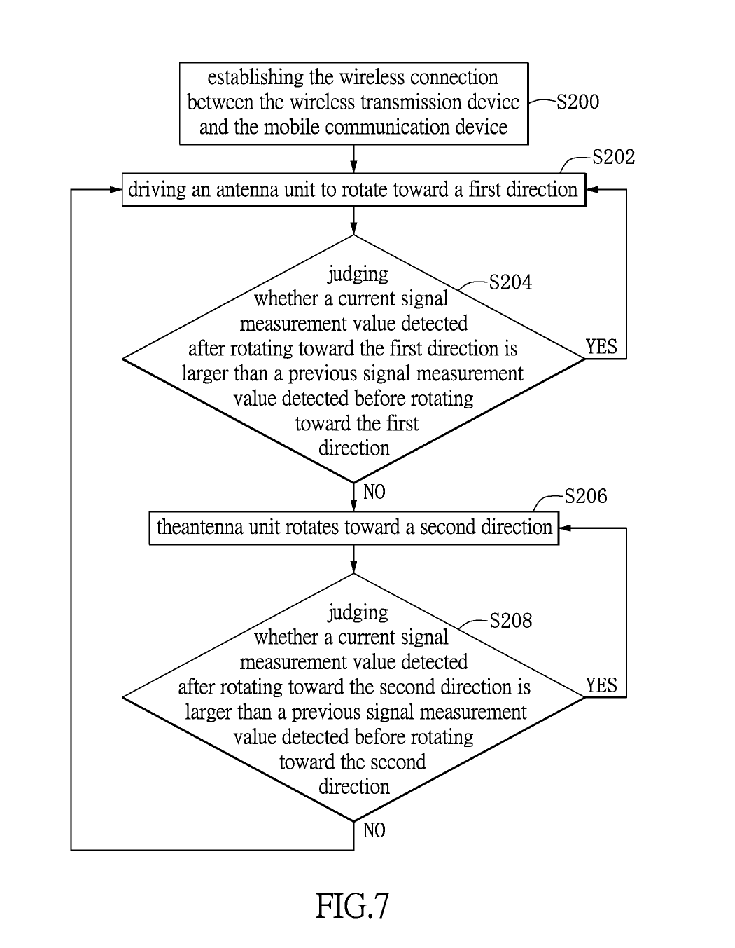

First, please refer to FIG. 7 and refer to FIG. 1 and FIG. 2 as needed. The third embodiment of the instant disclosure provides a method for connecting a wireless transmission device and a mobile communication device, comprising the steps of: as shown in step S200, establishing the wireless connection between the wireless transmission device 1 and the mobile communication device 2. Next, as shown in step S202, driving an antenna unit to rotate toward a first direction D1. The wireless connection manner and the rotation of the antenna unit 14 in step S200 and step S202 are similar to that of the previous embodiments, and are not described in detail herein.

As shown in step S204, judging whether a current signal measurement value detected after the antenna unit 14 rotates toward the first direction D1 is larger than the previous signal measurement value detected before the antenna unit 14 rotates toward the first direction D1. Before performing step S204, the method further comprising detecting the signal intensity between the wireless transmission device 1 and the mobile communication device 2 for obtaining the previous signal measurement value before the antenna unit 14 rotates toward the first direction D1. In other words, the current signal measurement value is the newest signal measurement value, and the previous signal measurement value is the signal measurement value obtained right before the newest signal value. By the processing and calculation of the control unit 12, the relative intensity between the current signal measurement value and the previous signal measurement value can ne determined.

As shown in step S206, when the current signal measurement value detected after the antenna unit 14 rotates toward the first direction D1 is not larger than the previous signal measurement value detected before the antenna unit 14 rotates toward the first direction D1, the antenna unit 14 is driven to rotate toward a second direction D2. In other words, when the current signal measurement value detected by the control unit 12 after the rotation is not larger than the previous signal measurement value detected before the rotation, the signal intensity is getting worse. Therefore, the control unit 12 controls the antenna unit 14 to rotate toward the second direction D2 opposite to the first direction D1.

In addition, when the current signal measurement value detected after the antenna unit 14 rotates toward the first direction D1 is larger than the previous signal measurement value detected before the antenna unit 14 rotates toward the first direction D1, continue to drive the antenna unit 14 to rotate toward the first direction D1. In other words, when the current signal measurement value detected by the control unit 12 after the rotation is larger than the previous signal measurement value detected before the rotation, the signal intensity is getting better. Therefore, the control unit 12 controls the antenna unit 14 to continue to rotate toward the first direction D1.

As shown in step S208, judging whether a current signal measurement value detected after the antenna unit 14 rotates toward the second direction D2 is larger than a previous signal measurement value detected before the antenna unit 14 rotates toward the second direction D2. Determining the relative intensity between the current signal measurement value and the previous signal measurement value by the processing and calculation of the control unit 12 to determine the direction of rotation of the antenna unit 14.

When the current signal measurement value detected after the antenna unit 14 rotates toward the second direction D2 is not larger than the previous signal measurement value detected before the antenna unit 14 rotates toward the second direction D2, go back to S202 to drive the antenna unit 14 to rotate toward the first direction D1.

Next, when the current signal measurement value detected after the antenna unit 14 rotates toward the second direction D2 is larger than the previous signal measurement value detected before the antenna unit 14 rotates toward the second direction D2, continue to drive the antenna unit 14 to rotate toward the second direction D2.

In addition, before performing step S202, i.e., the step of driving the antenna unit 14 to rotate toward the first direction D1, the method further comprises a step of judging whether the previous signal measurement value detected before the rotation toward the first direction D1 is larger than a predetermined signal measurement value. The predetermined signal measurement value in the third embodiment is equivalent to the predetermined signal measurement value described in the second embodiment and hence, is not described in detail herein.

When the previous signal measurement value detected before the rotation toward the first direction D1 is larger than the predetermined signal measurement value, stop the rotation of the antenna unit 14 until the signal measurement value is not larger than the predetermined signal measurement value. When the signal measurement value is not larger than the predetermined signal measurement value, performing the step S202.

Before the step of driving the antenna unit 14 toward the first direction D1, further comprising driving the antenna unit 14 to rotate toward the first direction D1 for a complete turn for recording the position of a best signal measurement value between the antenna unit 14 and the mobile communication device 2. The detail of the above step is described in the second embodiment and is not described in detail herein.

The method for connecting the wireless transmission device and the mobile communication device provided by the embodiment of the instant disclosure may further calculate the relative position between the mobile communication device 2 and the wireless transmission device 1. In other words, the position of the mobile communication device 2 may be located. After the step of judging whether the current signal measurement value detected after the antenna unit 14 rotates toward the second direction D2 is larger than the previous signal measurement value detected before the antenna unit 14 rotates toward the second direction D2, further comprising: calculating the relative position between the wireless transmission device 1 and the mobile communication device 2.

To be specific, the antenna unit 14 may be first driven to a position having the best signal measurement value with the mobile communication device 2 for obtaining the location of the mobile communication device 2 relative to the wireless transmission device 1. Next, the distance between the mobile communication device 2 and the wireless transmission device 1 may be calculated from the intensity of the signal measurement value, thereby locating the mobile communication device 2.

### Effectiveness of the Embodiments

In summary, the advantages of the instant disclosure are that the wireless transmission device 1 and the method for connecting the wireless transmission device 1 and the mobile communication device 2 is able to continuously detect the signal measurement value between the wireless transmission device 1 and the mobile communication device 2 to adjust the direction of the rotation of the antenna unit 14 for maintaining a best signal measurement value or communication quality between the wireless transmission device 1 and the mobile communication device 2.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A method for connecting a wireless transmission device with a mobile communication device, comprising:
step (a): establishing a wireless connection between the wireless transmission device and the mobile communication device;
step (b): detecting a signal measurement value between an antenna unit positioned at a predetermined position and the mobile communication device;
step (c): driving the antenna unit to rotate toward a first direction to another predetermined position for detecting another signal measurement value between the antenna unit and the mobile communication device; and
step (d): judging whether a signal measurement value detected laterally is larger than a signal measurement value detected previously;
wherein when the signal measurement value detected laterally is not larger than the signal measurement value detected previously, driving the antenna unit to rotate toward a second direction to yet another predetermined position for detecting yet another signal measurement value between the antenna unit and the mobile communication device, and performing step (d);
wherein when the signal measurement value detected laterally is larger than the signal measurement value detected previously, performing step (c).

2. The method according to claim 1, further comprising the following steps before performing step (a):
driving the antenna unit to rotate toward the first direction for a complete turn for recording a position of a best signal measurement value between the antenna unit and the mobile communication device; and
driving the antenna unit to rotate to the position of the best signal measurement value.

3. The method according to claim 1, further comprising the following step between step (b) and step (c):
judging whether the signal measurement value between the antenna unit positioned at the predetermined position and the mobile communication device is larger than a predetermined signal measurement value;
wherein when the signal measurement value between the antenna unit positioned at the predetermined position and the mobile communication device is not larger than the predetermined signal measurement value, performing step (c);
wherein when the signal measurement value between the antenna unit positioned at the predetermined position and the mobile communication device is larger than the predetermined signal measurement value, performing step (b).

4. A wireless transmission device for connecting a mobile communication device, comprising:
a base unit;
a control unit arranged on the base unit;
a steering unit arranged on the base unit and electrically connected to the control unit; and
an antenna unit arranged on the steering unit and electrically connected to the control unit;
wherein the control unit controls the direction of rotation of the steering unit according to a signal measurement value between the antenna unit and the mobile communication device for steering the antenna unit arranged on the steering unit.

5. The wireless transmission device according to claim 4, further comprising a signal connection unit arranged on the base unit and electrically connected to the control unit.

6. The wireless transmission device according to claim 4, wherein the antenna unit is a directional antenna.

7. A method for connecting a wireless transmission device with a mobile communication device, comprising:
establishing a wireless connection between the wireless transmission device and the mobile communication device;
driving an antenna unit to rotate toward a first direction;
judging whether a current signal measurement value detected after the antenna unit rotates toward the first direction is larger than a previous signal measurement value detected before the antenna unit rotates toward the first direction, wherein when the current signal measurement value detected after the antenna unit rotates toward the first direction is not larger than the previous signal measurement value detected before the antenna unit rotates toward the first direction, driving the antenna unit to rotate toward a second direction; and
judging whether a current signal measurement value detected after the antenna unit rotates toward the second direction is larger than a previous signal measurement value detected before the antenna unit rotates toward the second direction, wherein when the current signal measurement value detected after the antenna unit rotates toward the second direction is not larger than the previous signal measurement value detected before the antenna unit rotates toward the second direction, driving the antenna unit to rotate toward the first direction.

8. The method according to claim 7, wherein when the current signal measurement value detected after the antenna unit rotates toward the first direction is larger than the previous signal measurement value detected before the antenna unit rotates toward the first direction, driving the antenna unit to rotate toward the first direction.

9. The method according to claim 7, wherein when the current signal measurement value detected after the antenna unit rotates toward the second direction is larger than the previous signal measurement value detected before the antenna unit rotates toward the second direction, driving the antenna unit to rotate toward the second direction.

10. The method according to claim 7, wherein before performing the step of driving the antenna unit to rotate toward the first direction, further comprising:
detecting a signal intensity between the wireless transmission device and the mobile communication device for obtaining the previous signal measurement value detected before the antenna unit rotates toward the first direction.

11. The method according to claim 7, wherein after the step of judging whether the current signal measurement value detected after the antenna unit rotates toward the second direction is larger than the previously signal measurement value detected before the antenna unit rotates toward the second direction, further comprising:
calculating a relative position between the mobile communication device and the wireless transmission device.
